(19) United States
(12) Patent Application Publication
(10) Pub. No.: US 2023/0182300 A1
(43) Pub. Date: Jun. 15, 2023

(54) SYSTEMS AND METHODS FOR ROBOT COLLISION AVOIDANCE

(71) Applicant: Boston Dynamics, Inc., Waltham, MA (US)

(72) Inventor: Matthew Paul Meduna, Waltham, MA (US)

(73) Assignee: Boston Dynamics, Inc., Waltham, MA (US)

(21) Appl. No.: 17/988,482

(22) Filed: Nov. 16, 2022

Related U.S. Application Data
(60) Provisional application No. 63/288,392, filed on Dec. 10, 2021.

(51) Int. Cl. B25J 9/16; B25J 15/06; B25J 5/00

(52) U.S. Cl. CPC B25J 9/1666; B25J 9/1676; B25J 9/1651; B25J 9/162; B25J 15/0683; B25J 5/007

(57) ABSTRACT

A virtual bumper configured to protect a component of a robotic device from damage is provided. The virtual bumper comprises a plurality of distance sensors arranged on the robotic device and at least one computing device configured to receive distance measurement signals from the plurality of distance sensors, detect, based on the received distance measurement signals, at least one object in a motion path of the component, and control the robot to change one or more operations of the robot to avoid a collision between the component and the at least one object.

### CROSS REFERENCE TO RELATED APPLICATIONS

This application claims the benefit under 35 U.S.C. § 119(e) of U.S. Provisional application Ser. No. 63/288,392, filed Dec. 10, 2021, and entitled, “SYSTEMS AND METHODS FOR ROBOT COLLISION AVOIDANCE,” the disclosure of which is incorporated by reference in its entirety.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

Some robots are configured to implement “pick and place” operations in which objects grasped by the robot at one location are moved by the robot to another location. However, sometimes such robots operate without complete information about their environment, resulting in one or more of the robot components being damaged when it comes into contact with an object that was not accurately observed and/or modeled by the robot. For instance, an object (e.g., a box) may be located in a different location than the robot expected, or a portion (e.g., a wall or ceiling) of an enclosure (e.g., a truck) in which the robot is operating may be located at a distance closer to the robot than expected.

Repairing damage to robot components that collide with such objects is costly and results in downtime for the robot. To this end, some embodiments relate to detecting such objects in the environment of a robot by arranging a “virtual bumper” around at least a portion of a robot component (e.g., an end effector such as a gripper). Using the virtual bumper to detect such objects enables the robot to change its operation (e.g., by slowing its arm down as it approaches the object and stopping it) before a collision with the object occurs.

One aspect of the present disclosure provides a virtual bumper configured to protect a component of a robotic device from damage. The virtual bumper comprises a plurality of distance sensors arranged on the robotic device and at least one computing device. The at least one computing device is configured to receive distance measurement signals from the plurality of distance sensors, detect, based on the received distance measurement signals, at least one object in a motion path of the component, and control the robot to change one or more operations of the robot to avoid a collision between the component and the at least one object.

In another aspect, the plurality of distance sensors are arranged on the component of the robotic device.

In another aspect, the plurality of distance sensors are time-of-flight (TOF) sensors.

In another aspect, at least two of the plurality of distance sensors are configured to sense objects in different directions.

In another aspect, a first distance sensor of the plurality of distance sensors is configured to sense objects in a first direction and a second distance sensor of the plurality of distance sensors is configured to sense objects in a second direction orthogonal to the first direction.

In another aspect, the component is a gripper of the robotic device, the gripper includes a plurality of suction cup assemblies, and the first direction is along a length of the plurality of suction cup assemblies.

In another aspect, the component is a gripper of the robotic device.

In another aspect, the gripper includes a first side arranged along a first axis, a second side arranged along a second axis perpendicular to the first axis, and a plurality of suction cup assemblies, each of which has a length arranged along a third axis perpendicular to the first and second axes, a first distance sensor of the plurality of distance sensors is arranged on the first side and is configured to sense objects in a first direction along the second axis, and a second distance sensor of the plurality of distance sensors is arranged on the second side and is configured to sense objects in a second direction along the first axis.

In another aspect, a third distance sensor of the plurality of distance sensors is configured to sense objects in a third direction along the third axis.

In another aspect, a fourth distance sensor of the plurality of distance sensors is configured to sense objects in the third direction along the third axis.

In another aspect, the gripper includes a third side arranged opposite the first side along the first axis and a fourth side arranged opposite the second side along a second axis, wherein a fifth distance sensor of the plurality of distance sensors is arranged on the third side and is configured to sense objects in a fourth direction along the second axis, and a sixth distance sensor of the plurality of distance sensors is arranged on the fourth side and is configured to sense objects in a fifth direction along the first axis.

In another aspect, detecting at least one object in a motion path of the component comprises detecting the at least one object when a plurality of points represented in the distance measurement signals are located below a threshold distance from the component.

In another aspect, the received distance measurement signals include first measurement signals received from a first distance sensor and second measurement signals received from a second distance sensor, and the at least one computing device is further configured to process the first measurement signals and the second measurement signals differently to detect at least one object in the motion path of the component.

In another aspect, processing the first measurement signals and the second measurement signals differently comprises comparing the first measurement signals to a first threshold distance and comparing the second measurement signals to a second threshold distance different than the first threshold distance.

In another aspect, the first threshold distance and/or the second threshold distance is determined based on at least one characteristic of the object grasped by the component.

In another aspect, processing the first measurement signals and the second measurement signals differently comprises ignoring the first measurement signals or the second measurement signals when detecting the at least one object in the motion path of the component.

In another aspect, controlling the robot to change one or more operations of the robot comprises changing a speed of an arm of the robot to which the component is coupled.

In another aspect, changing a speed of the arm of the robot comprises changing a speed of the arm of the robot based on a distance between the component and the detected at least one object.

In another aspect, changing a speed of the arm of the robot comprises stopping the arm of the robot.

In another aspect, controlling the robot to change one or more operations of the robot comprises changing a trajectory of an arm of the robot to which the component is coupled.

In another aspect, controlling the robot to change one or more operations of the robot comprises changing an orientation of a wrist assembly coupled to the component.

In another aspect, the at least one object is a portion of an enclosure in the environment of the robot.

In another aspect, the portion of the enclosure comprises a ceiling of the enclosure and/or at least one wall of the enclosure.

Another aspect of the present disclosure provides a mobile manipulator robot. The mobile manipulator robot comprises a mobile base, an arm coupled to the mobile base, a gripper coupled to the arm, wherein the gripper includes a plurality of distance sensors arranged thereon, and a controller configured to control an operation of the mobile manipulator robot to avoid a collision of the gripper with an object detected based, at least in part, on distance measurement signals sensed by the plurality of distance sensors.

In another aspect, a first distance sensor of the plurality of distance sensors is configured to sense objects in a first direction and a second distance sensor of the plurality of distance sensors is configured to sense objects in a second direction different than the first direction.

In another aspect, the gripper includes a plurality of suction cup assemblies, and the first direction is along a length of the plurality of suction cup assemblies.

In another aspect, the gripper includes a first side arranged along a first axis, a second side arranged along a second axis perpendicular to the first axis, and a plurality of suction cup assemblies, each of which has a length arranged along a third axis perpendicular to the first and second axes, a first distance sensor of the plurality of distance sensors is arranged on the first side and is configured to sense objects in a first direction along the second axis, and a second distance sensor of the plurality of distance sensors is arranged on the second side and is configured to sense objects in a second direction along the first axis.

In another aspect, a third distance sensor of the plurality of distance sensors is configured to sense objects in a third direction along the third axis.

In another aspect, a fourth distance sensor of the plurality of distance sensors is configured to sense objects in the third direction along the third axis.

In another aspect, the gripper includes a third side arranged opposite the first side along the first axis and a fourth side arranged opposite the second side along a second axis, a fifth distance sensor of the plurality of distance sensors is arranged on the third side and is configured to sense objects in a fourth direction along the second axis, and a sixth distance sensor of the plurality of distance sensors is arranged on the fourth side and is configured to sense objects in a fifth direction along the first axis.

In another aspect, controlling an operation of the mobile manipulator robot comprises one or more of changing a speed of the arm of the robot, changing a trajectory of an arm of the robot to which the component is coupled, or changing an orientation of a wrist assembly coupled to the component.

Another aspect of the present disclosure provides a gripper for use with a mobile robotic device. The gripper comprises a first side arranged along a first axis, a second side arranged along a second axis, a plurality of suction cup assemblies, each of which has a length arranged along a third axis, a first distance sensor arranged on the first side and configured to sense objects in a first direction along the second axis, and a second distance sensor arranged on the second side and configured to sense objects in a second direction along the first axis.

In another aspect, the first axis and the second axis are perpendicular.

In another aspect, the third axis is perpendicular to each of the first and second axes.

In another aspect, the gripper further comprises a third distance sensor configured to sense objects in a third direction along the third axis.

In another aspect, the gripper further comprises a fourth distance sensor configured to sense objects in the third direction along the third axis.

In another aspect, the gripper further comprises a third side arranged opposite the first side along the first axis, a fourth side arranged opposite the second side along a second axis, a fifth distance sensor arranged on the third side and configured to sense objects in a fourth direction along the second axis, and a sixth distance sensor arranged on the fourth side and configured to sense objects in a fifth direction along the first axis.

Another aspect of the present disclosure provides a method of preventing damage to a component of a robotic device. The method comprises sensing distance measurement data using a plurality of distance sensors arranged on the component, detecting, by at least one computing device based on the sensed distance measurement data, at least one object in a motion path of the component, and controlling, by the at least one computing device, at least one operation of the robot to avoid a collision between the component and the at least one object.

In another aspect, the component is a gripper of the robotic device.

In another aspect, detecting at least one object in a motion path of the component comprises detecting the at least one object when a plurality of points represented in the distance measurement signals are located below a threshold distance from the component.

In another aspect, the received distance measurement signals include first measurement signals received from a first distance sensor of the plurality of distance sensors and second measurement signals received from a second distance sensor of the plurality of distance sensors, and the method further comprises processing the first measurement signals and the second measurement signals differently to detect at least one object in the motion path of the component.

In another aspect, processing the first measurement signals and the second measurement signals differently comprises comparing the first measurement signals to a first threshold distance and comparing the second measurement signals to a second threshold distance different than the first threshold distance.

In another aspect, controlling at least one operation of the robot comprises changing a speed of an arm of the robot to which the component is coupled.

In another aspect, changing a speed of the arm of the robot comprises changing a speed of the arm of the robot based on a distance between the component and the detected at least one object.

In another aspect, changing a speed of the arm of the robot comprises stopping the arm of the robot.

In another aspect, controlling at least one operation of the robot comprises changing a trajectory of an arm of the robot to which the component is coupled.

In another aspect, controlling at least one operation of the robot comprises changing an orientation of a wrist assembly coupled to the component.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of one embodiment of a robot;

FIG. 1B is another perspective view of the robot of FIG. 1A;

FIG. 2A depicts robots performing tasks in a warehouse environment;

FIG. 2B depicts a robot unloading boxes from a truck;

FIG. 2C depicts a robot building a pallet in a warehouse aisle;

FIG. 3 depicts an end-effector portion of a robot in which a plurality of distance sensors are disposed therein in accordance with some embodiments;

FIG. 4 depicts a schematic of a computer architecture configured to process distance measurements to control a robot in accordance with some embodiments; and

FIG. 5 is a flowchart of a process for implementing a virtual bumper in accordance with some embodiments.

### DETAILED DESCRIPTION

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions. Such robots may either be specialist robots (i.e., designed to perform a single task, or a small number of closely related tasks) or generalist robots (i.e., designed to perform a wide variety of tasks). To date, both specialist and generalist warehouse robots have been associated with significant limitations, as explained below.

A specialist robot may be designed to perform a single task, such as unloading boxes from a truck onto a conveyor belt. While such specialist robots may be efficient at performing their designated task, they may be unable to perform other, tangentially related tasks in any capacity. As such, either a person or a separate robot (e.g., another specialist robot designed for a different task) may be needed to perform the next task(s) in the sequence. As such, a warehouse may need to invest in multiple specialist robots to perform a sequence of tasks, or may need to rely on a hybrid operation in which there are frequent robot-to-human or human-to-robot handoffs of objects.

In contrast, a generalist robot may be designed to perform a wide variety of tasks, and may be able to take a box through a large portion of the box's life cycle from the truck to the shelf (e.g., unloading, palletizing, transporting, depalletizing, storing). While such generalist robots may perform a variety of tasks, they may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible. Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task. As should be appreciated from the foregoing, the mobile base and the manipulator in such systems are effectively two separate robots that have been joined together; accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while there are limitations that arise from a purely engineering perspective, there are additional limitations that must be imposed to comply with safety regulations. For instance, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not a pose a threat to the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, the inventors have recognized and appreciated that a highly integrated mobile manipulator robot with system-level mechanical design and holistic control strategies between the manipulator and the mobile base may be associated with certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

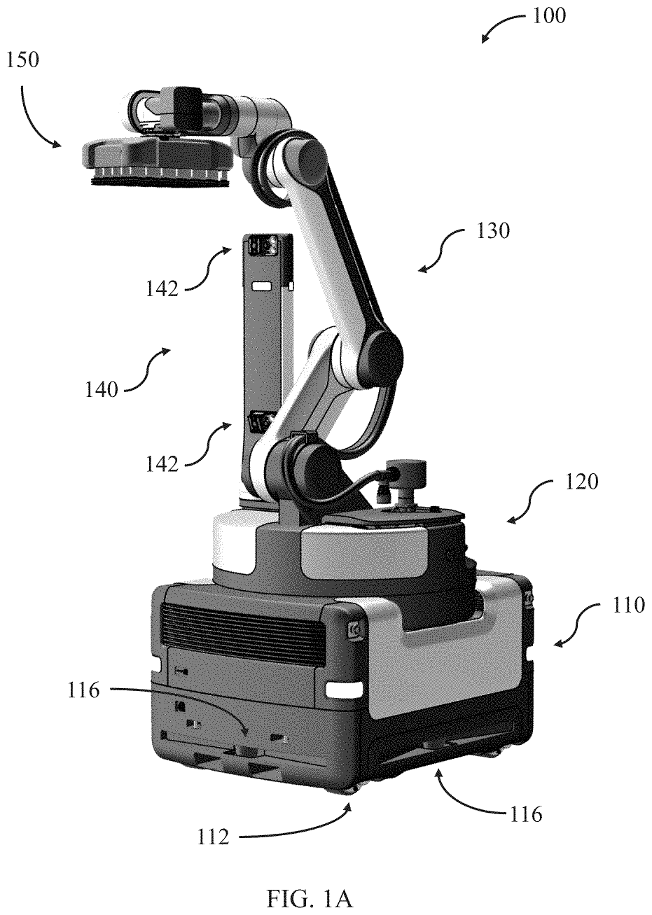

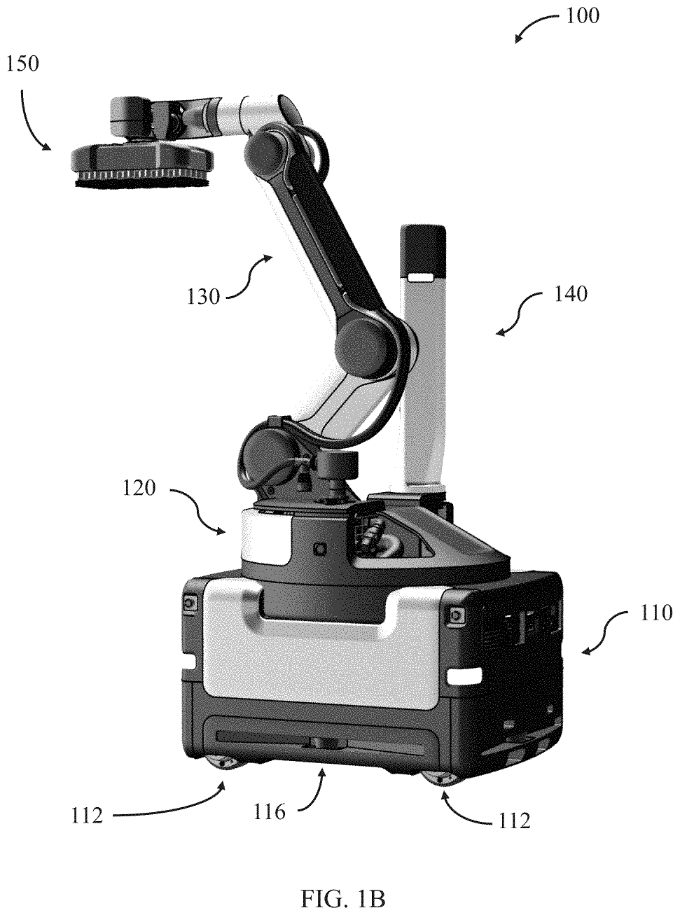

FIGS. 1A and 1B are perspective views of one embodiment of a robot 100. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

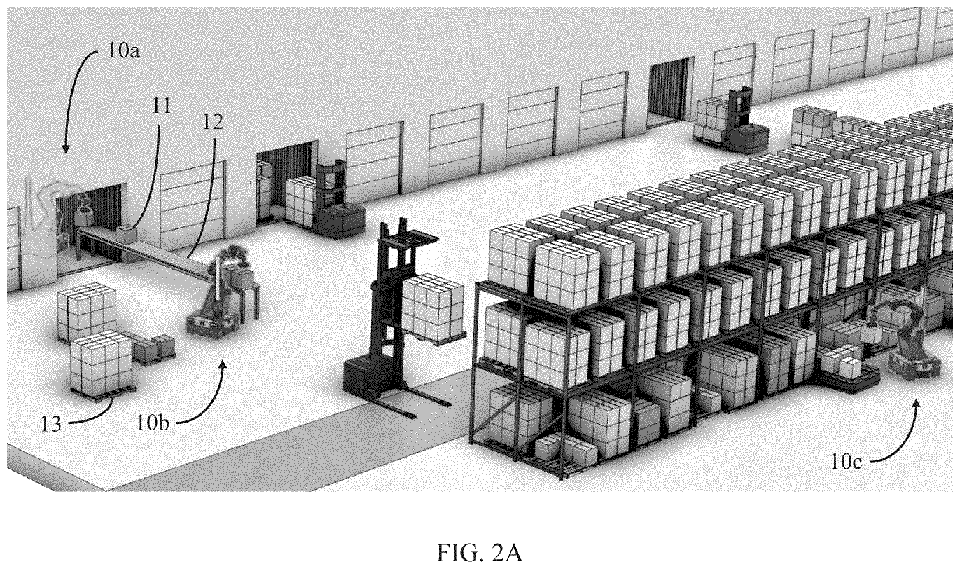

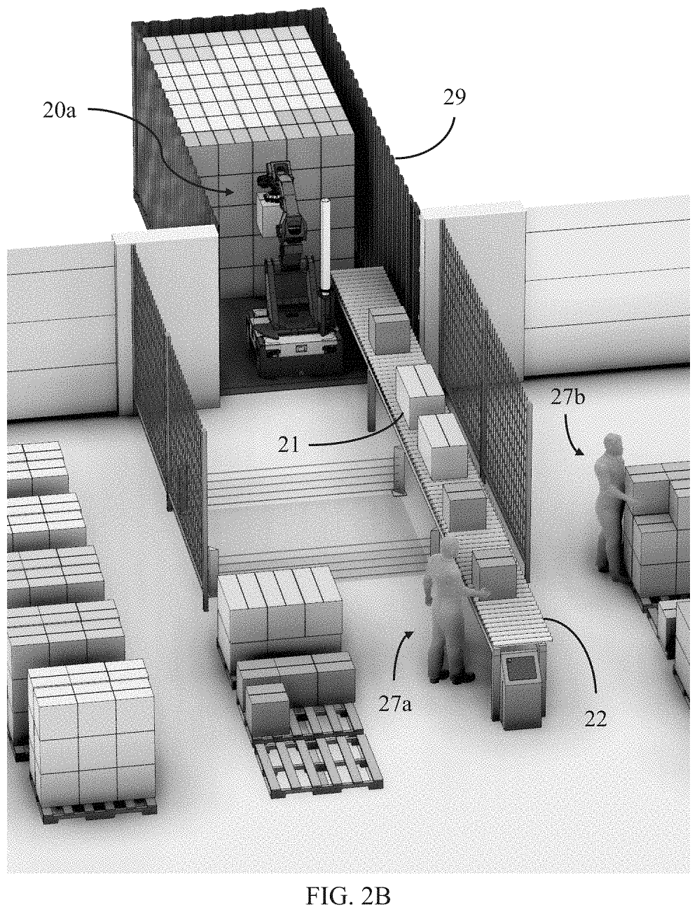

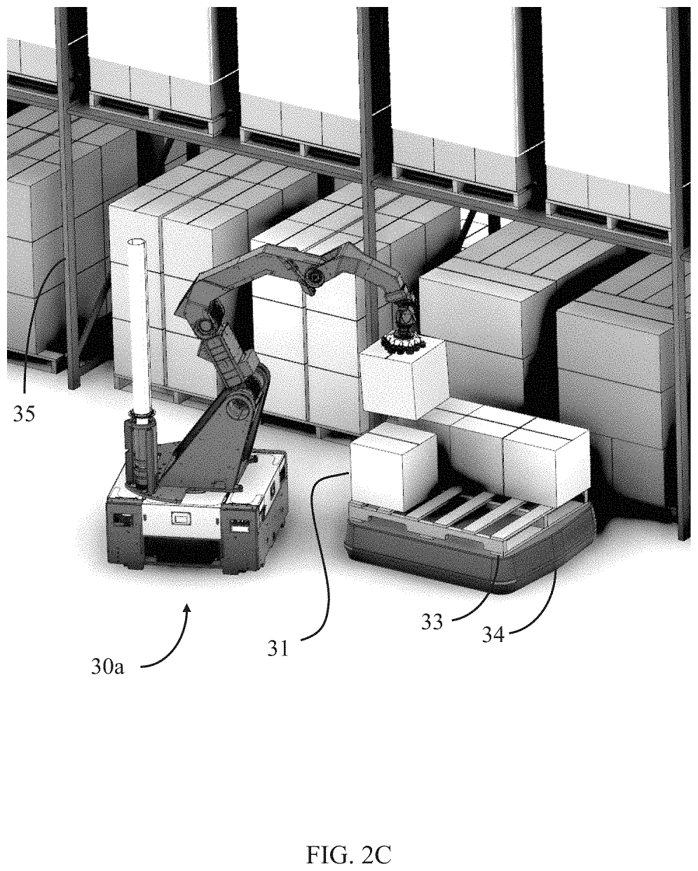

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). It should be appreciated that the robots 10a, 10b, and 10c are different instances of the same robot (or of highly similar robots). Accordingly, the robots described herein may be understood as specialized multi-purpose robots, in that they are designed to perform specific tasks accurately and efficiently, but are not limited to only one or a small number of specific tasks.

FIG. 2B depicts a robot 20a unloading boxes 21 from a truck 29 and placing them on a conveyor belt 22. In this box picking application (as well as in other box picking applications), the robot 20a will repetitiously pick a box, rotate, place the box, and rotate back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B. During operation, the perception mast of robot 20a (analogous to the perception mast 140 of robot 100 of FIGS. 1A and 1B) may be configured to rotate independent of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot into which humans are prevented from entering.

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

Of course, it should be appreciated that the tasks depicted in FIGS. 2A-2C are but a few examples of applications in which an integrated mobile manipulator robot may be used, and the present disclosure is not limited to robots configured to perform only these specific tasks. For example, the robots described herein may be suited to perform tasks including, but not limited to, removing objects from a truck or container, placing objects on a conveyor belt, removing objects from a conveyor belt, organizing objects into a stack, organizing objects on a pallet, placing objects on a shelf, organizing objects on a shelf, removing objects from a shelf, picking objects from the top (e.g., performing a “top pick”), picking objects from a side (e.g., performing a “face pick”), coordinating with other mobile manipulator robots, coordinating with other warehouse robots (e.g., coordinating with AMRs), coordinating with humans, and many other tasks.

The perception system (e.g., including perception mast 140 and its associated perception modules) of a mobile robot can be used, among other things, to periodically capture images of the environment near the robot. The robot can then process the captured images to estimate the positions of objects in the environment, such as the ceiling and walls of an enclosure in which the robot is working and/or the location of other objects (e.g., boxes) near the robot, among other things. The inventors have recognized that information about objects in the environment derived from images captured by the robot's perception system may not always accurately represent the state of the robot's environment at all points in time. For instance, the environment may include unanticipated geometries (e.g., a step in the ceiling of a truck, a bulge in a wall of the truck, boxes that have fallen or partially fallen to the ground, etc.) that were not observed from the captured images, and which leave the robot susceptible to damage if not taken into account. To this end, some embodiments are directed to using a plurality of distance sensors mounted on a robotic component (e.g., a gripper) to supplement information from the perception system of the robot in an effort to avoid collisions with objects in the environment of the robot. Example Virtual Bumper for a Robotic Component

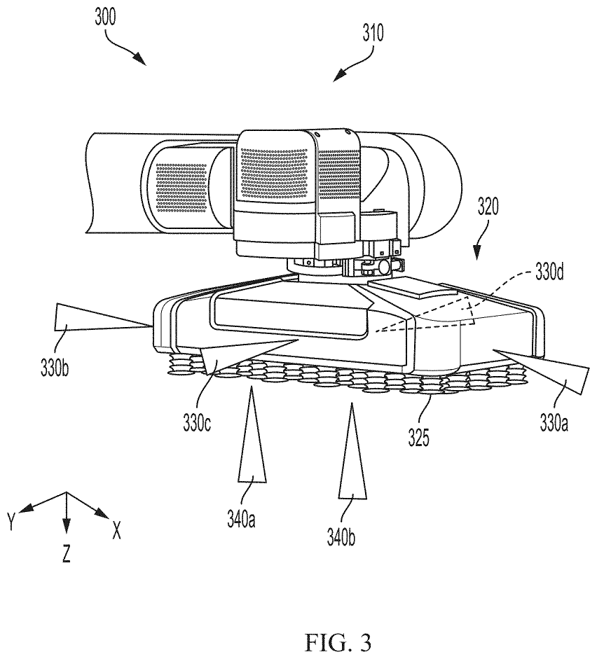

FIG. 3 illustrates an example of a robotic component 300 that may be associated with a virtual bumper in accordance with some embodiments. As shown, robotic component 300 corresponds to an end-effector portion of the robot and includes a wrist assembly 310 coupled to an arm of the robot, and a gripper 320 coupled to the wrist assembly 310. Gripper 320 may be configured as a vacuum-based gripper in which suction is applied through a plurality of suction cup assemblies 325 configured to grasp an object (e.g., a box) when suction is applied through them.

The inventors have recognized and appreciated that certain components of a robotic device, such as the end-effector components shown in FIG. 3, are at higher risk of inadvertently colliding with objects in the environment of the robot when the robot is in operation. In an effort to protect such components from collisions, some embodiments form a “virtual bumper” around at least a portion of the robotic component 300 to detect objects in the vicinity of the component that may result in collision if avoidance measures are not taken. In the example described in FIG. 3, the robotic component around which a virtual bumper is formed is the gripper of the robot. It should be appreciated, however, that other robotic components (e.g., another end effector, an elbow joint of a robotic arm, etc.) may additionally or alternatively have a virtual bumper formed around them using one or more of the components and techniques described herein.

In some embodiments, the virtual bumper is implemented using a plurality of distance sensors arranged on the robotic component to be protected. In the example of FIG. 3, the plurality of distance sensors include sensors arranged to detect objects in different directions. For instance, sensors 330a and 330b are arranged on opposite sides of gripper 320 and are configured to detect objects in the +/−X direction. Sensors 330c and 330d are arranged on opposite sides of gripper 320 and are configured to detect objects in the +/−Y direction. Sensors 340a and 340b are arranged in different locations on the cup assembly (gripping) surface and are configured to detect objects in the +Z direction (the suction direction). By providing multiple direction sensors arranged in different directions, a virtual sensing buffer that surrounds gripper 320 may be implemented. Although six distance sensors are shown, it should be appreciated that more or fewer distance sensors may alternatively be used. For instance, distance sensors arranged on the top of the gripper 320 closest to the wrist assembly 312 and configured to detect objects in the −Z direction may also be used. Additionally, rather than having a virtual bumper configured to sense objects in all directions (X, Y, Z), in some embodiments, a smaller set of sensors is used, such that a virtual bumper is implemented to surround only a portion of the robotic component at any one point in time. Although it is possible to use a smaller number of sensors oriented in only a few directions (or one direction) to create a virtual bumper, in such cases, the robot may need to move the robotic component in multiple directions to obtain a full view of objects in the environment, which generally is undesirable, as implementing such behavior would slow the normal picking operation of the robot. Additionally, although the example virtual bumper in FIG. 3 is shown using two distance sensors 340a, 340b oriented in the same (Z) direction, it should be appreciated that in some embodiments, only a single Z-directed distance sensor may be used.

In some embodiments, distance sensors 330a-d and 340a-b are implemented as time-of-flight (TOF) sensors configured to detect signals reflected by an object located near (e.g., within 2 meters of) the robotic component 300. Other types of distance sensors including, but not limited to, acoustic-based (e.g., SONAR) distance sensors may alternatively be used.

In some embodiments, the size of the virtual bumper surrounding the robotic component may be fixed (e.g., the size may not be changeable) such that each of the distance sensors is configured to detect objects within a fixed distance (e.g., 2 meters) from the robotic component. In other embodiments, at least some of the distance sensors may be configured to detect objects within a variable distance that can be set based on one or more factors or criteria. Enabling variable control of the size and/or shape of the virtual bumper adds flexibility to the design, such that the virtual bumper may be adapted to different robot operating environments in which having a smaller, larger or differently-shaped virtual bumper may be advantageous.

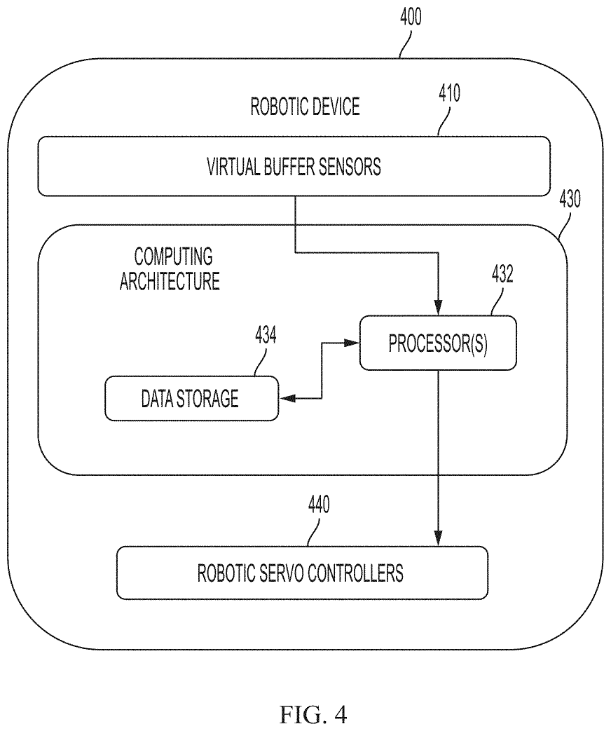

In some embodiments, the virtual bumper is uniform in that all of the distance sensors used to form the virtual bumper are configured to detect objects within a same distance. In some embodiments, at least some of the distance sensors used to form the virtual bumper are configured to detect objects at different distances to produce a non-uniform virtual bumper around the robotic component (e.g., the virtual bumper may be larger in some directions than other directions). It should be appreciated that “configuring a distance sensor” to detect objects at different distances may be implemented in hardware, software, or some combination of hardware and software. For instance, in some embodiments, the same hardware (e.g., TOF sensors) is used for all distance sensors incorporated into the robotic component, and the size and/or shape of the virtual bumper is changed by altering the way in which distance measurement signals sensed by the distance sensors are processed (e.g., by one or more computer processors, described in more detail below with regard to FIG. 4).

In some embodiments, the size of the virtual bumper may be adjusted based, at least in part, on a speed that the robotic component (e.g., the gripper) is traveling. For instance, when the gripper (and/or the arm to which it is coupled) is traveling at a slow speed, the size of the virtual bumper may be smaller compared to when the gripper is traveling at a higher speed. In some embodiments, the size of the virtual bumper may be set based, at least in part, on a speed limit associated with the robotic arm (or some other component) of the robot.

In some embodiments, the size and/or shape of the virtual bumper may be adjusted based, at least in part, on one or more characteristics (size, shape, placement on gripper, etc.) of an object that the gripper has grasped. For instance, an object that has overhang on one side of the gripper but not the other side may result in a different configuration of the virtual bumper than when an object centered on the gripper has no overhang on either side.

In some embodiments, one or more of the distance sensors forming the virtual bumper may be configured to be switched off or “muted.” For instance, if sensed distance measurements are noisy, it may be an indication that the corresponding distance sensor is not operating properly and should be muted. It should be appreciated that when a distance sensor is muted, it is not necessarily turned off, but instead data from that sensor may merely be ignored during processing of the distance measurement signals.

In some embodiments, the distance sensors arranged to form a virtual bumper may be configured to continuously (e.g., every few milliseconds) sense distance measurement data such that objects can be detected in real-time as the robot is operating to enable real-time control of robotic motion in an attempt to avoid collisions. Distance measurement signals sensed by the distance sensors may be provided to one or more computer processors for processing to detect objects in the path of the robotic component that could result in a collision. In response to detecting such possible collisions, a motion of the robot (e.g., a motion of the robotic arm) to which the robotic component is coupled may be changed. For instance, when detecting an object that may result in a collision, the robot may be controlled to slow the speed of (or stop) the robotic arm in an attempt to avoid the collision. Additionally or alternatively, the trajectory of the robotic arm and/or the end effector portion of the robotic arm may be dynamically changed in an attempt to avoid the collision.

In some embodiments, the distance sensors 340a-b configured to detect objects in the Z direction (through the suction cup assemblies) may include a different type of distance sensors (or be configured differently) than the distance sensors 330a-d arranged on the sides of the gripper 320. For instance, distance sensors 340a-b being arranged on the suction cup assembly surface should have a transmit cone small enough to fit between the suction cup assemblies, whereas the distance sensors 330a-d may not have such restrictions. Accordingly, in some embodiments the distance sensors 330a-d are configured to have a larger field of view than the distance sensors 340a-b.

Distance sensors 340a-b may be configured differently than distance sensors 330a-d in other ways as well. For instance, distance sensors 340a-b may be used to detect not only objects that may possibly collide with gripper 320, but may also be used to detect objects that the gripper is in the process of grasping or has already grasped. In the case of objects to be grasped, distance measurements to an object surface (e.g., a box face) that is to be grasped by the gripper may be used to, among other things, determine when to apply suction through one or more of the suction cup assemblies 320. In the case of an object that has already been grasped, distance measurements to the object surface may be used to detect if the object is moving away from the gripper surface and is at risk of being dropped by the robot. Upon detection that the object is at risk of being dropped, the robot may be controlled to reduce an acceleration of the arm, rotate the wrist assembly to improve the grasp, or take some other action to mitigate the risk of the object being dropped by the robot.

In some embodiments, locating the distance sensors associated with the virtual bumper on a robotic component that can be manipulated with dexterity enables for distance measurements to be made in ways that may not be possible with the perception system of the robot. For instance, the perception mast of the robot described in connection with FIGS. 1A and 1B is fixed to the base of the robot. By locating the distance sensors on the gripper of the robot, that portion of the robot may be inserted into an environment (e.g., a truck or other enclosure) prior to driving the entire robot into the enclosure (e.g., while the robot is located on a ramp leading into the truck). In this way, the distance sensors of the virtual bumper may provide a rough description of objects in the environment in which the robot plans to operate prior to entering the environment.

### Example Computing Device

Control of one or more of the robotic arm, the mobile base, the turntable, and the perception mast may be accomplished using one or more computing devices located on-board the mobile manipulator robot. For instance, one or more computing devices may be located within a portion of the mobile base with connections extending between the one or more computing devices and components of the robot that provide sensing capabilities and components of the robot to be controlled. In some embodiments, the one or more computing devices may be coupled to dedicated hardware configured to send control signals to particular components of the robot to effectuate operation of the various robot systems. In some embodiments, the mobile manipulator robot may include a dedicated safety-rated computing device configured to integrate with safety systems that ensure safe operation of the robot.

The computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the terms “physical processor” or “computer processor” generally refer to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

FIG. 4 illustrates an example computing architecture 410 for a robotic device 400, according to an illustrative embodiment of the invention. The computing architecture 410 includes one or more processors 432 and data storage 434 in communication with processor(s) 432. Robotic device 400 may also include virtual bumper sensors 410 (which may include, e.g., distance sensors 330a-d and/or 340a-b described above in connection with FIG. 3). Distance measurements captured by the virtual bumper sensors 410 may be provided as input to processor(s) 432, which may be programmed to detect one or more objects in proximity to the virtual bumper sensors 410. Data storage 434 may be configured to store information used by processor(s) 432 to process distance measurements captured by the virtual bumper sensors 410, examples of which are discussed above. Robotic device 400 may also include robotic servo controllers 440, which may be in communication with processor(s) 432 and may receive control commands from processor(s) 432 to move a corresponding portion of the robotic device. For example, when processor(s) 432 determines that an object is within close proximity to one of the virtual bumper sensors, the processor(s) 432 may issue control instructions to robotic servo controllers 440 to slow operation of an arm in an attempt to avoid a collision between the robotic device 400 and the detected object.

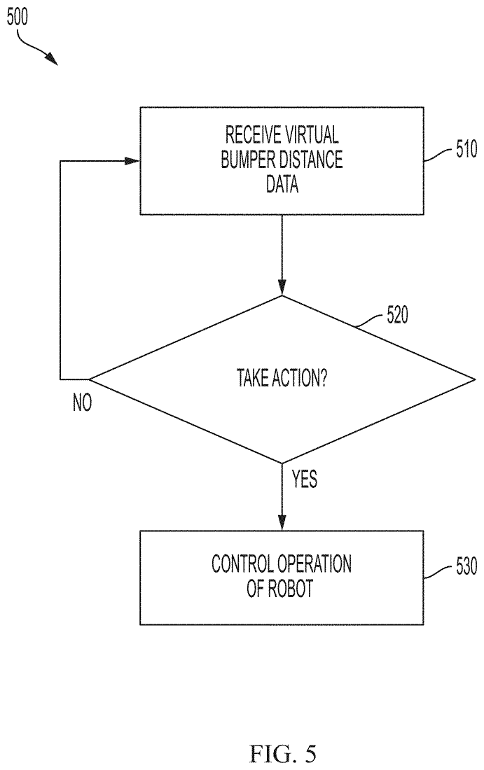

FIG. 5 illustrates a process 500 for controlling an operation of a robot based on use of a virtual bumper in accordance with some embodiments. In act 510, virtual bumper distance data is received from one or more distance sensors (e.g., TOF sensors) arranged on a robotic component (e.g., a gripper) to be protected. Process 500 proceeds to act 510, where the virtual bumper distance data is processed by one or more computer processors to determine whether an action should be taken. Several examples of processing the virtual bumper distance data have been described above in connection with FIG. 3 including, but not limited to, determining a likely collision with an object, determining that the gripper is nearing an object to be grasped, and/or determining that a grasped object is at risk of being dropped by the gripper. If it is determined that no action need be taken, process 500 returns to act 510, in which new virtual bumper distance data is received. If it is determined in act 520 that an action should be taken based on the processed virtual bumper distance data, process 500 proceeds to act 520, in which one or more operations of the robot are controlled based, at least in part, on the processed virtual bumper distance data. Several non-limiting examples of controlling an operation of the robot have been described above in connection with FIG. 3 including, but not limited to, changing a speed and/or trajectory of the robot arm, changing the application of suction by the gripper and/or adjusting a position of one or more robotic components (e.g., the wrist assembly) to prevent dropping of a grasped object.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that embodiments of a robot may include at least one non-transitory computer-readable storage medium (e.g., a computer memory, a portable memory, a compact disk, etc.) encoded with a computer program (i.e., a plurality of instructions), which, when executed on a processor, performs one or more of the above-discussed functions. Those functions, for example, may include control of the robot and/or driving a wheel or arm of the robot. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A virtual bumper configured to protect a component of a robotic device from damage, the virtual bumper comprising:
a plurality of distance sensors arranged on the robotic device; and
at least one computing device configured to:
receive distance measurement signals from the plurality of distance sensors;
detect, based on the received distance measurement signals, at least one object in a motion path of the component; and
control the robot to change one or more operations of the robot to avoid a collision between the component and the at least one object.

2. The virtual bumper of claim 1, wherein the plurality of distance sensors are arranged on the component of the robotic device.

3. The virtual bumper of claim 1, wherein the plurality of distance sensors are time-of-flight (TOF) sensors.

4. The virtual bumper of claim 1, wherein at least two of the plurality of distance sensors are configured to sense objects in different directions.

5. The virtual bumper of claim 4, wherein a first distance sensor of the plurality of distance sensors is configured to sense objects in a first direction and a second distance sensor of the plurality of distance sensors is configured to sense objects in a second direction orthogonal to the first direction.

6. The virtual bumper of claim 5, wherein
the component is a gripper of the robotic device, the gripper including a plurality of suction cup assemblies, and
the first direction is along a length of the plurality of suction cup assemblies.

7. The virtual bumper of claim 1, wherein
the component is a gripper of the robotic device,
the gripper includes a first side arranged along a first axis, a second side arranged along a second axis perpendicular to the first axis, and a plurality of suction cup assemblies, each of which has a length arranged along a third axis perpendicular to the first and second axes,
the gripper includes a third side arranged opposite the first side along the first axis and a fourth side arranged opposite the second side along a second axis,
a first distance sensor of the plurality of distance sensors is arranged on the first side and is configured to sense objects in a first direction along the second axis,
a second distance sensor of the plurality of distance sensors is arranged on the second side and is configured to sense objects in a second direction along the first axis,
a third distance sensor of the plurality of distance sensors is configured to sense objects in a third direction along the third axis,
a fourth distance sensor of the plurality of distance sensors is configured to sense objects in the third direction along the third axis,
a fifth distance sensor of the plurality of distance sensors is arranged on the third side and is configured to sense objects in a fourth direction along the second axis, and
a sixth distance sensor of the plurality of distance sensors is arranged on the fourth side and is configured to sense objects in a fifth direction along the first axis.

8. The virtual bumper of claim 1, wherein detecting at least one object in a motion path of the component comprises detecting the at least one object when a plurality of points represented in the distance measurement signals are located below a threshold distance from the component.

9. The virtual bumper of claim 1, wherein the received distance measurement signals include first measurement signals received from a first distance sensor and second measurement signals received from a second distance sensor, and wherein the at least one computing device is further configured to:
process the first measurement signals and the second measurement signals differently to detect at least one object in the motion path of the component.

10. The virtual bumper of claim 9, wherein processing the first measurement signals and the second measurement signals differently comprises comparing the first measurement signals to a first threshold distance and comparing the second measurement signals to a second threshold distance different than the first threshold distance and/or ignoring the first measurement signals or the second measurement signals when detecting the at least one object in the motion path of the component.

11. The virtual bumper of claim 10, wherein the first threshold distance and/or the second threshold distance is determined based on at least one characteristic of the object grasped by the component.

12. The virtual bumper of claim 1, wherein controlling the robot to change one or more operations of the robot comprises one or more of changing a speed of an arm of the robot to which the component is coupled, changing a trajectory of an arm of the robot to which the component is coupled, or changing an orientation of a wrist assembly coupled to the component.

13. The virtual bumper of claim 12, wherein changing a speed of the arm of the robot comprises changing a speed of the arm of the robot based on a distance between the component and the detected at least one object or stopping the arm of the robot.

14. A mobile manipulator robot, comprising:
a mobile base;
an arm coupled to the mobile base;
a gripper coupled to the arm, wherein the gripper includes a plurality of distance sensors arranged thereon; and
a controller configured to control an operation of the mobile manipulator robot to avoid a collision of the gripper with an object detected based, at least in part, on distance measurement signals sensed by the plurality of distance sensors.

15. The mobile manipulator robot of claim 14, wherein
the gripper includes a first side arranged along a first axis, a second side arranged along a second axis perpendicular to the first axis, and a plurality of suction cup assemblies, each of which has a length arranged along a third axis perpendicular to the first and second axes,
the gripper includes a third side arranged opposite the first side along the first axis and a fourth side arranged opposite the second side along a second axis,
a first distance sensor of the plurality of distance sensors is arranged on the first side and is configured to sense objects in a first direction along the second axis,
a second distance sensor of the plurality of distance sensors is arranged on the second side and is configured to sense objects in a second direction along the first axis,
a third distance sensor of the plurality of distance sensors is configured to sense objects in a third direction along the third axis,
a fourth distance sensor of the plurality of distance sensors is configured to sense objects in the third direction along the third axis,
a fifth distance sensor of the plurality of distance sensors is arranged on the third side and is configured to sense objects in a fourth direction along the second axis, and
a sixth distance sensor of the plurality of distance sensors is arranged on the fourth side and is configured to sense objects in a fifth direction along the first axis.

16. The mobile manipulator robot of claim 14, wherein controlling an operation of the mobile manipulator robot comprises one or more of changing a speed of the arm of the robot, changing a trajectory of an arm of the robot to which the component is coupled, or changing an orientation of a wrist assembly coupled to the component.

17. A method of preventing damage to a component of a robotic device, the method comprising:
sensing distance measurement data using a plurality of distance sensors arranged on the component;
detecting, by at least one computing device based on the sensed distance measurement data, at least one object in a motion path of the component; and
controlling, by the at least one computing device, at least one operation of the robot to avoid a collision between the component and the at least one object.

18. The method of claim 17, wherein detecting at least one object in a motion path of the component comprises detecting the at least one object when a plurality of points represented in distance measurement data are located below a threshold distance from the component.

19. The method of claim 17, wherein the distance measurement data includes first measurement signals received from a first distance sensor of the plurality of distance sensors and second measurement signals received from a second distance sensor of the plurality of distance sensors, and wherein the method further comprises:
processing the first measurement signals and the second measurement signals differently to detect at least one object in the motion path of the component,
wherein processing the first measurement signals and the second measurement signals differently comprises comparing the first measurement signals to a first threshold distance and comparing the second measurement signals to a second threshold distance different than the first threshold distance.

20. The method of claim 17, wherein controlling at least one operation of the robot comprises one or more of changing a speed of an arm of the robot to which the component is coupled, changing a changing a trajectory of an arm of the robot to which the component is coupled, or changing an orientation of a wrist assembly coupled to the component.

21. The method of claim 20, wherein changing a speed of the arm of the robot comprises changing a speed of the arm of the robot based on a distance between the component and the detected at least one object or stopping the arm of the robot.
